(19) United States
(12) Patent Application Publication
(10) Pub. No.: US 2013/0021453 A1
(43) Pub. Date: Jan. 24, 2013

(54) Autostereoscopic rear-view display system for vehicles

(71) Applicants: Jean-Paul Gignac, Lasalle (CA); Stephen Sutherland, Markham (CA)

(72) Inventors: Jean-Paul Gignac, Lasalle (CA); Stephen Sutherland, Markham (CA)

(21) Appl. No.: 13/137,127

(22) Filed: Jul. 22, 2011

(51) Int. Cl. H04N 13/04

(52) U.S. Cl. 348/51; 348/E13.001

(57) ABSTRACT

A vehicle monitoring system uses at least one image capture device located on a vehicle and provides two or more associated images for combined display on an autostereoscopic display provided adjacent an operator. Preferably the images are processed for display and provide the operator with visual information that otherwise may not be available. The invention is directed to both apparatus and method for providing of this information.

### FIELD OF THE INVENTION

The present invention relates to vehicle perimeter visibility systems, vehicle driver interfaces and safety mechanisms.

### BACKGROUND OF THE INVENTION

It is now relatively common to have vehicles equipped with camera systems and in particular rear view cameras that are used in combination with a display provided near a driver for assistance in vehicle operation. The rear view camera and display are available as retrofit or original equipment in vehicles and some of these display systems are provided as part of a rear view mirror.

It has also been proposed to use a series of sensors about a vehicle to provide a warning system that .may assist a driver with respect to areas where visibility is difficult or not possible. Numerous camera backup systems are available for passenger vehicles, motor homes, trucks and tractor trailers.

In addition to visual capture systems there are a host of mirror systems that are available for improved monitoring of a vehicle's perimeter.

Although these systems provide additional information that may assist an operator of a vehicle, safety and the collecting and processing of information regarding vehicle operation remains the responsibility of the operator. Unfortunately there remains the issue that not all information is provided or the information may be presented in a manner that requires significant interpretation.

The present invention provides a more effective approach for gathering and displaying of information for the safe operation of a vehicle in a modified format for improved communication of the information.

### SUMMARY OF THE INVENTION

A vehicle monitoring system according to the present invention comprises at least one image capture device located on a vehicle and providing two or more associated images on a predetermined basis to allow combined display on an autostereoscopic display provided adjacent a vehicle operator's position. A communication arrangement links the at least one image capture device to a computer provided as part of the monitoring system and the two or more associated images are transmitted to the computer. The computer processes the two or more associated images and based thereon transmits two image signals to the autostereoscopic display. The autostereoscopic display receives and displays the two image signals to provide information that otherwise may not be visually available to an operator of the vehicle.

In an aspect of the invention, the autostereoscopic display is mounted in the manner of a rear view mirror for adjustment by the operator to improve image recognition.

In an aspect of the invention, the at least one image capture device is positioned and captures a rear view of the vehicle.

In a further aspect of the invention, the autostereoscopic display replaces a rearview mirror and is adjustably mounted in a similar location.

According to a preferred aspect of the invention, the computer processes multiple images and derives a presentation of the information displayed on the display that otherwise is not available from the vehicle.

In a preferred embodiment of the invention, the presentation of information is from a viewpoint above the vehicle looking down.

Preferably the system cooperates with additional image signals transmitted to the vehicle monitoring system that originate external to the vehicle monitoring system. Desirably some of the additional image signals are transmitted from non-vehicle stationary sources.

In a preferred structure, additional image signals are transmitted from other vehicle monitoring systems determined to be in close proximity to the vehicle monitoring system.

### BRIEF DESCRIPTION OF THE DRAWINGS

Preferred embodiments of the invention are shown in the drawings, wherein:

FIG. 1 illustrates a stereoscopic camera 6 mounted magnetically to the back of a truck;

FIG. 2 illustrates an autostereoscopic display 7 mounted to the windshield of a truck, displaying an unobstructed rearward view from the truck, as captured by the stereoscopic camera 6 of FIG. 1;

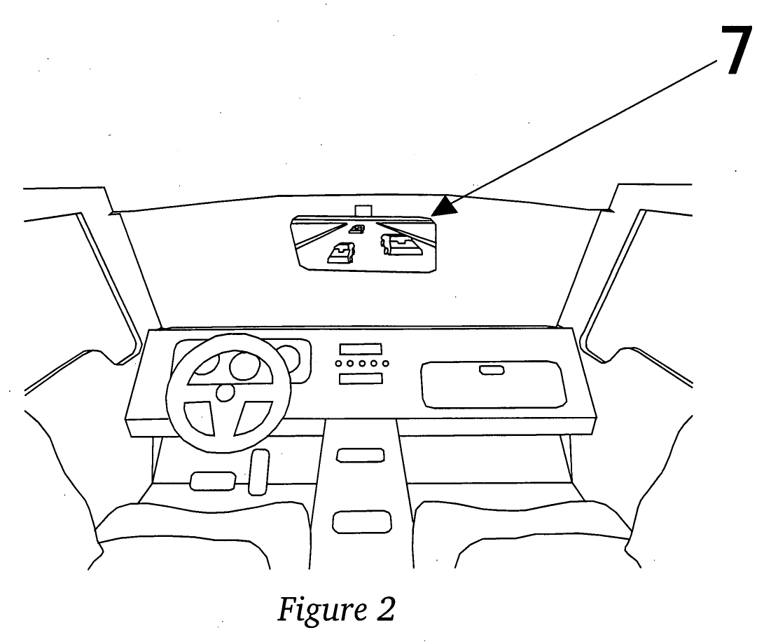

FIG. 3 illustrates a vehicle 1 with multiple real cameras 2 mounted along its perimeter, in a setting with multiple obstructions 3, and a virtual camera 4 positioned above the vehicle, pointed downwards; and

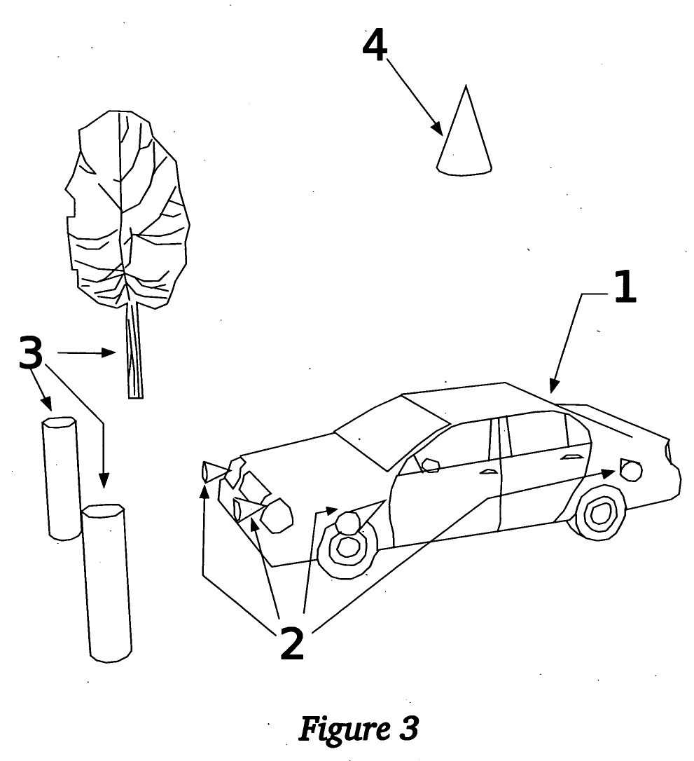

FIG. 4 illustrates the interior of the vehicle of FIG. 3, with an autostereoscopic display 5 mounted in the windshield, displaying a view of the vehicle and its surroundings as rendered from the perspective of the virtual camera of FIG. 3.

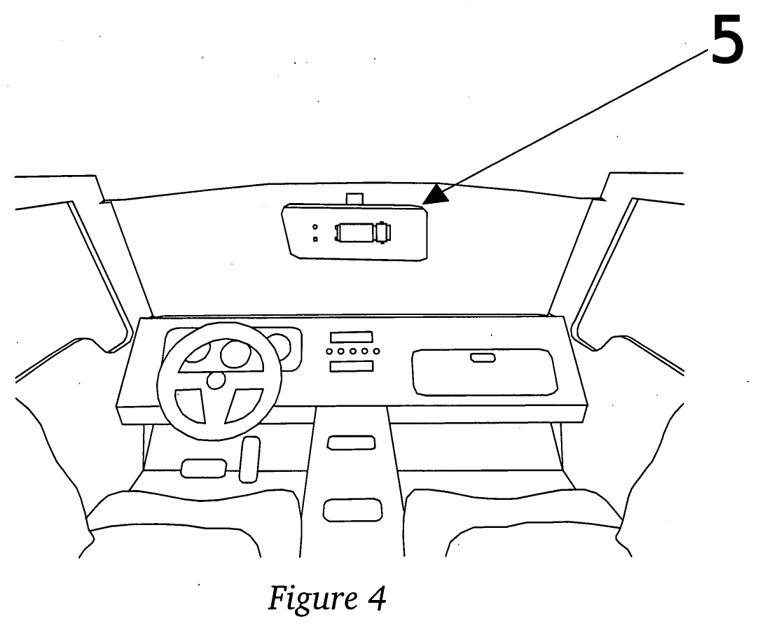

### DETAILED DESCRIPTION OF THE PREFERRED EMBODIMENTS

Safe operation of a vehicle relies to a very significant extent on the individual skill of the operator and the ability of the operator to collect and process information. Information is constantly changing and in most cases different mirrors about the vehicle assist the operator in collecting information. More recently cameras and visual displays have supplemented this information. One of the primary sources of information is the rear view mirror of a vehicle such as a passenger vehicle. For some vehicles such as trucks and tractor trailers, the rear view mirror is of no assistance as it is effectively blocked by the structure of the vehicle. Sophisticated side mirrors attempt to capture this lost information.

In the present invention an autostereoscopic display is provided and it is preferable that this display is located to allow the operator to use the display for the effective communication of information. Preferably the autostereoscopic display is mounted to the windshield of a truck or other vehicle in the same manner as an adjustable rear view mirror mount. In particular a ball joint mount is used to allow movement of the screen for improved screen viewing and image interpretation.

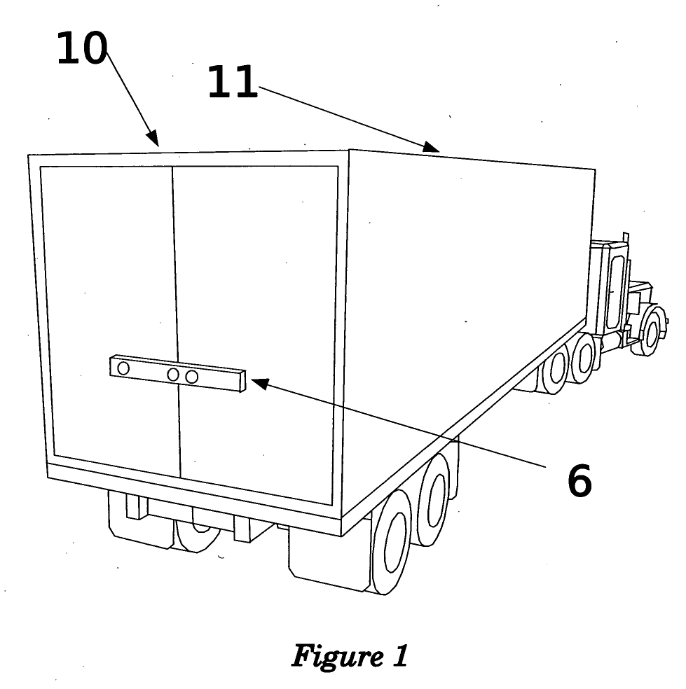

One or more cameras are attached at different locations on the vehicle to capture two images for display on an autostereoscopic display. In FIG. 1 a camera 6 is mounted magnetically to the back of a truck 10 and captures two similar images. The capture of these two images allows simultaneous display of these images on the autostereoscopic display 7 to present the operator with enhanced vehicle information. There is no requirement to wear 3-dimensional glasses or specialized eye wear or head gear to interpret the displayed image. Preferably the camera includes a wireless connection and transmits the captured images to a network router via a suitable protocol and this information is then forwarded and/or processed and provided to the autostereoscopic display typically by a wired Ethernet link or other suitable communication link. The wireless connection from the camera to the router allows for a portable capture system however in some permanent applications a hard-wired system is used.

The orientation of the autostereoscopic display is adjustable to allow the driver to orientate the rear view autostereoscopic display to optimize the quality of the viewing effect.

It is possible to use a single camera that captures two images however it is preferable to use multiple cooperating cameras for capture of several different images or viewpoints for display. For example, two cameras on opposite corners of the vehicle will have a known spacing therebetween and the images from these cameras can be appropriately processed to produce appropriate images for simultaneous display. With the present invention, the information captured by the various cameras or sensors is preferably processed and displayed in a manner that assists the operator of the vehicle and may provide viewpoints not previously available. For example, a series of cameras or sensors provided about the vehicle can provide images of assistance in parking of the vehicle. The captured images can be processed to provide a representation of the vehicle as opposed to the actual image of the vehicle while providing actual perimeter information. For example, it may be desired to process the captured information and provide an effective overhead view where the perimeter of the vehicle is displayed and the area exterior to this perimeter is also presented. This may be a depiction of the vehicle perimeter in combination with one or more derived or actual views outwardly from the vehicle. The orientation of the captured information may be altered to produce one or more different orientations that would not normally be available to the operator of the vehicle.

As can be appreciated in a parallel parking type application, it may be desirable to have a bird's eye view of the vehicle to assist in the parking thereof. The actual cameras would not be above the vehicle but the data can be processed to provide this type of image for assistance to the operator. Information can be provided from other sources such as permanent non-vehicle fixed sensors, signals from other vehicles, satellite signals or GPS information.

In the safe operation of a vehicle certain information is more valuable depending upon the direction of movement of the vehicle. If the vehicle is moving forward, the forward view is typically more important than the rearward view. Similarly if the vehicle is moving rearwardly the rearward view is of higher importance. The autostereoscopic display can be divided or appropriately proportioned to provide this type of information and the more important view may be of a larger scale or area on the screen. In some applications only a single view is provided whereas in other circumstances multiple views may be presented.

The system has been described with respect to information collection and processing and displaying where the information is provided by cameras or sensors on the vehicle. The present system can also advantageously use information that may be available in the near proximity to a vehicle. Such additional information can be provided by stationary sensors that have been previously located, for example a series of sensors could be provided on highways, bridges, parking lots or other fixed locations. The vehicle monitoring system can receive this additional information and integrate it into the display system. It is also possible to use the information that may be available from other vehicles having a similar system in the near proximity to the vehicle. The display system can utilize this combination of information sources and display the relative location of the different vehicles. External vehicle sources of information may be valuable in poor visibility applications such as snow or fog conditions and this information can be processed together with speed and geographic positions. For example if a vehicle ahead is stopped or rapidly decelerating and a possible collision condition is present a warning signal could be produced. As can be appreciated GPS information can be of assistance in determining relative positions and what sources of information may be of assistance.

Various warnings and safety systems can be incorporated into the present invention. Furthermore the display itself can have a series of manually executed buttons for the production of a particular image desired by the operator. Display options or controls can also be provided on or at the steering wheel or control.

The present autostereoscopic display can replace an existing rearview mirror or merely supplement such a system. The real time processing of the signals from the various cameras or sensors provided with the vehicle is completed within an effective time frame.

The display of the information has been described with respect to the incorporation thereof in a device similar to or as part of a rear view mirror. It is also possible to include such a display as part of a vehicle dashboard, windshield or in other locations for easy interpretation by the operator. It is also possible that the system would use a mobile display or, one that is easily set up by the operator.

There are a number of autostereoscopic display systems that are suitable for this particular application. Additional features of the invention are outlined below.

The preferred embodiment enhances a truck which otherwise has an obstructed rearward view due to its payload trailer 11 by using an autostereoscopic display as a virtual rear-view mirror.

As used herein, an autostereoscopic display is any electronically-controlled device which displays images or video in such a way that it is generally perceived 3-dimensionally by one or more viewers who are not wearing 3D glasses, or any other sort of special eye wear or head gear.

An autostereoscopic display is mounted to the windshield of the truck using a typical ball-joint rear-view mirror mount. A camera is attached magnetically to the back of the payload trailer for capture of appropriate images. The camera captures an unobstructed rearward view from the back of the trailer. Preferably the camera wirelessly transmits the captured rearward views to a network router via an IEEE 802.11n local network link. The network router further transmits the captured rearward views to the autostereoscopic display preferably by a wired Ethernet link or the views are subsequently processed and modified for display.

The orientation of the autostereoscopic display is adjusted by the driver in a way similar to the adjustment of a typical rear-view mirror.

However, whereas the orientation of a rear-view mirror is adjusted so as to optimize the reflected viewing angle, the orientation of the autostereoscopic display is adjusted so as to optimize the quality presented image.

Other embodiments may include other types of capture devices providing the rearward view. For example, two or more individual cameras can be used and the signals processed to create a desired image viewpoint. The captured images may additionally include images in the infrared spectrum, or in other normally invisible domains, to help with challenging lighting situations or particular applications.

Other embodiments may locate the display in alternative positions within the vehicle, including on the vehicle dashboard, or on or around the instrument display panel, or in a convenient location within the driver's sight. Alternately, the display could be mobile and/or relocatable. The display might be a portable device such as an HTC EVO 3D which can be fastened in a visible location within the vehicle.

The rearward view may be communicated to the display either wirelessly, or via wires, using variants of 902.11 (WiFi), Blue-Tooth, Ethernet, I2C, NTSC, ATSC, SPI, or any other existing or future communication protocol. The autostereoscopic display and rearward view capture devices may be powered by batteries (rechargeable or otherwise) or other energy storage devices, or by the vehicle electrical system.

The rearward view capture device may be mounted by any means, temporarily or permanently, to the rear of the vehicle, or to the top or bottom or side of the vehicle, or to any other location on the vehicle capable of providing the necessary view. A multi-part capture device, such as a pair of cameras, or a 3D depth map capture device, may have components mounted to various different locations. In the case of a tractor trailer, sensors may be mounted both to the truck and to the trailer to provide added sensory data.

Image processing may be used to help the driver identify objects of special interest such as objects likely to collide with the vehicle, or animate objects, such as animals or people. Other information may be superimposed on the display. Audible alerts may be employed to provide further assistance. The system may also provide guidance to help the driver navigate around or between obstructions.

The system can employ a memory storage capability for temporary storage of data. This can be helpful in the event of an accident or collision. Such temporary storage can be fixed in the event of detected collision or accident conditions. In some cases, for example commercial vehicles a camera capturing the operator may also be provided and built into the display. This may be helpful to confirm operator fatigue etc. It can also be used to detect operator fatigue and produce a warning signal before an accident occurs. Such a warning signal or recorded signal can be transmitted to a remote station.

The autostereoscopic display could also be used to display augmented frontward or sideward-facing views. For instance, it could provide terrain and hazard mapping in cases of limited visibility due to inclement weather.

The display system may provide a wider-angle display than what would typically be achievable with a standard rear-view mirror. The display angle could also be modifiable either manually (by the driver or by a passenger), or automatically based on circumstances such as whether the vehicle is in forward or reverse gear.

The autostereoscopic display may be used as a better alternative to a traditional rear-view mirror even in vehicles with relatively good visibility. For instance, a typical family vehicle may at times carry luggage piled up so as to obscure the view through the rear windshield. More generally, a composited multi-camera system could provide a wide-angle view that is unobstructed by the vehicle support structure, and is free of blind spots.

In order to more realistically simulate a standard rear-view mirror, the autostereoscopic display may be altered using a lens, or a Fresnel lens, or other technology to adjust the focal distance between the driver and the plane of the display.

Using 3-dimensional reconstruction and rendering techniques, views normally unavailable may be presented on the display. For example, a view from several metres overhead, looking downwards may be presented in order to facilitate parallel parking, or, more generally, parking in tight conditions. Depending on the positions of the capture devices, the vehicle itself or portions thereof may not be in view. In this case, a model of the vehicle, or portions thereof may be superimposed onto either the reconstructed 3-dimensional scene model, or directly onto the rendered image.

3-dimensional reconstruction and rendering from alternative viewpoints is well understood in the fields of computer vision and computer graphics, respectively. There are various well-understood methods of accomplishing each of these techniques. A novel aspect of this invention is the employment of these techniques to present useful alternative viewpoints to the operator of a vehicle. Another novel aspect is the use of an autostereoscopic display to enhance the realism of rendered or photographed imagery presented to the operator of a vehicle. Another novel aspect is the mounting of an autostereoscopic display in the windshield of a vehicle, where one would commonly place a traditional rear-view mirror.

A driver-visible display can present many kinds of data in various forms to augment the driving experience, or to increase safety or convenience. The presented data may be collected from sensors either internal or external to the vehicle, or via wireless communications from remote locations such as nearby intersections, or distant intersections, or satellites, or other vehicles. For example, in tight parking areas, external cameras or ultrasonic distance sensors, or other types or sensors may be installed by the operator of the parking facility. Using a published protocol, these sensors may link with the vehicle's on-board system to provide the video and/or sensor feed along with information about the location/capabilities of the camera/sensor. Another example consists of a grid of sensors (cameras, motion detectors, etc.) installed at intersections where accidents had previously occurred frequently. As a vehicle approaches such intersection, the vehicle's system would dynamically link with this sensor grid to seamlessly integrate the input from these sensors to better notify the driver of possible hazards (cars, pedestrians, dogs, etc.) This system can also be used as part of a dynamic sensor grid by vehicles as they travel on roads/highways. If one vehicle's sensors detect hazards, they can communicate such information to others. Alternatively, they may transmit the raw sensor data to all surrounding vehicles.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A vehicle monitoring system comprising at least one'image capture device located on a vehicle and providing two or more associated images on a predetermined basis to allow combined display on an autostereoscopic display provided adjacent a vehicle operator's position, said at least one image capture device is connected to a computer provided as part of said monitoring system and said two or more associated images are transmitted to said computer,
said computer processing said two or more associated images and based thereon transmits two image signals to said autostereoscopic display,
said autostereoscopic display receiving and displaying the two image signals to provide information that otherwise may not be visually available to an operator of the vehicle.

2. A vehicle monitoring system as claimed in claim 1 wherein said autostereoscopic display is mounted in the manner of a rear view mirror for adjustment by the operator to improve image recognition.

3. A vehicle monitoring system as claimed in claim 1 wherein said at least one image capture device is positioned and captures a rear view of the vehicle.

4. A vehicle monitoring system as claimed in claim 2 wherein said at least one image capture device is positioned and captures a rear view of the vehicle.

5. A vehicle monitoring system as claimed in claim 1 wherein said autostereoscopic display replaces a rearview mirror and is adjustably mounted in a similar location.

6. A vehicle monitoring system as claimed in claim 2 wherein said autostereoscopic display replaces a rearview mirror and is adjustably mounted in a similar location.

7. A vehicle monitoring system as claimed in claim 1 wherein said computer processes multiple images and derives a presentation of the information displayed on said display that otherwise is not available from the vehicle.

8. A vehicle monitoring system as claimed in claim 5 wherein said presentation of information is from a viewpoint above the vehicle looking down.

9. A vehicle monitoring system as claimed in claim 1 wherein said system cooperates with additional image signals transmitted to said vehicle monitoring system and originating external to said vehicle monitoring system.

10. A vehicle monitoring system as claimed in claim 2 wherein said system cooperates with additional image signals transmitted to said vehicle monitoring system and originating external to said vehicle monitoring system.

11. A vehicle monitoring system as claimed in claim 9 wherein said additional image signals are transmitted from stationary sources.

12. A vehicle monitoring system as claimed in claim 11 wherein said additional image signals are transmitted from other vehicle monitoring systems determined to be in close proximity to the vehicle monitoring system.
